(19) United States
(12) Patent Application Publication
(10) Pub. No.: US 2014/0184611 A1
(43) Pub. Date: Jul. 3, 2014

(54) METHOD AND APPARATUS FOR SENDING PARTIAL FRAME UPDATES RENDERED IN A GRAPHICS PROCESSOR TO A DISPLAY USING FRAMELOCK SIGNALS

(71) Applicant: NVIDIA CORPORATION, Santa Clara, CA (US)

(72) Inventors: David Wyatt, San Jose, CA (US); David Stears, San Jose, CA (US)

(73) Assignee: NVIDIA CORPORATION, Santa Clara, CA (US)

(21) Appl. No.: 13/732,063

(22) Filed: Dec. 31, 2012

(51) Int. Cl. G09G 3/00

(52) U.S. Cl. CPC G09G 3/00
USPC 345/501

(57) ABSTRACT

Embodiments of the present invention may include a graphics processor operable to generate video frames, wherein the graphics processor is operable to begin generating a partial update region of a video frame upon receiving a framelock signal. Further, a screen refresh controller may be communicatively coupled with the graphics processor, wherein the screen refresh controller is operable to receive partial update regions of video frames from the graphics processor and send framelock signals to the graphics processor. Additionally, a display device may be communicatively coupled with the screen refresh controller, wherein the display device is operable to receive and display video frames from the screen refresh controller.

### CROSS-REFERENCE TO RELATED APPLICATIONS

The following copending U.S. patent application Ser. No. 13/185,381, “METHOD AND APPARATUS FOR PERFORMING BURST REFRESH OF A SELF-REFRESHING DISPLAY DEVICE,” Attorney Docket NVDA/SC-11-0024-US1, David Wyatt, filed Jul. 18, 2011, is incorporated herein by reference for all purposes.

This application is related to the following U.S. patent application: U.S. patent application Ser. No. ______, “METHOD AND APPARATUS FOR SYNCHRONIZING A LOWER BANDWIDTH GRAPHICS PROCESSOR WITH A HIGHER BANDWIDTH DISPLAY USING FRAMELOCK SIGNALS,” Attorney Docket NVID P-SC-11-0248-US1, David Wyatt, filed ______.

### BACKGROUND OF THE INVENTION

Typically, video to be ultimately displayed on a display device may be generated by a graphics processing unit (GPU). Before frames of the video may be displayed on the display device, the frames may be stored in a frame buffer. A frame buffer may be a portion of memory reserved for holding a complete frame or bit-mapped image that may be sent to a display. Typically, a frame buffer may be stored in the memory chips on a video adapter. In some cases, however, the video chipset may be integrated into a motherboard design and the frame buffer may be stored in general main memory. The frame buffer may drive the display device with the frame stored in memory.

A typical screen refresh cycle on a display device may involve scanning out a frame to be visible on a display device, at a fixed pixel clock rate, one line at a time, until the frame may completely scanned-out, and then repeating the process for subsequent frames. Thus, to support ever higher resolutions at a typical screen refresh rate may require the use of very high-speed pixel clocks, and since each pixel may need to be read from a frame buffer at a faster rate, a faster memory in a graphics controller may be required in order to provide the pixels for display at the display interface in time to meet the refresh rate timing requirements.

Computer systems typically include a display device, such as a liquid crystal display (LCD) device, coupled with a graphics controller. During normal operation, the graphics controller generates video signals that are transmitted to the display device by scanning-out pixel data from a frame buffer based on timing information generated within the graphics controller. Some recently designed display devices have a self-refresh capability, where the display device includes a local controller configured to generate video signals from a static, cached frame of digital video independently from the graphics controller. When in such a self-refresh mode, the video signals are driven by the local controller, thereby allowing portions of the graphics controller to be turned off to reduce the overall power consumption of the computer system. Once in self-refresh mode, when the image to be displayed needs to be updated, control may be transitioned back to the graphics controller to allow new video signals to be generated based on a new set of pixel data.

When in a self-refresh mode, the graphics controller may be placed in a power-saving state such as a deep sleep state. In addition, the main communications channel between a central processing unit (CPU) and the graphics controller may be turned off to conserve energy. When the image needs to be updated, the computer system “wakes-up” the graphics controller and any associated communications channels. The graphics controller may then process the new image data and transmit the processed image data to the display device for display.

Designing a high-speed frame buffer memory interface in handheld, mobile, and entry-level GPUs may increase cost. Further, higher resolutions may not be used in every mode or use of a device. Additionally, unless an asymmetric memory configuration is supported, the high-speed operation may require all system memory to run at the higher speed, which may add a cost burden in an integrated graphics system. Given these factors, mobile, handheld, and entry-level graphics units typically cannot support driving high resolution display devices because they tend to use slower and less expensive memory.

This limitation presents challenges for systems that use a combination of high-end and low-end GPUs to provide superior battery-life and performance, for example, hybrid/switchable notebooks and other technology systems. Hybrid/switchable systems may be system where a low-end GPU used for battery-life cannot drive the panel at the same refresh rate as a high-end GPU used for performance, and it is often not possible to seamlessly transition from one GPU driving the display to the other. Some systems may use a power-efficient iGPU to drive the screen continuously, while a dGPU provides rendered results directly into the iGPU's frame buffer for display. In these systems, the ability of the system to support a high resolution display may be limited by the lowest common denominator, e.g., the iGPU max pixel clock.

While a high-performance GPU typically may have a faster local memory frame buffer and may drive high resolution and/or refresh displays, a more power-efficient GPU may not. Accordingly, the maximum resolution a GPU system can drive may be limited to the maximum resolution capability of the GPU. Moreover, these GPU systems typically must support multiple displays, therefore even if a GPU is capable of driving a main display at full resolution, it may not be capable of driving the main display at the same time as driving other displays.

### BRIEF SUMMARY OF THE INVENTION

Accordingly, embodiments of the invention are directed to methods and systems for providing frames to a display, at a display frame rate of a display, from a GPU that may otherwise have a regular maximum frame generation rate that is lower than the display frame rate. For example, a GPU may be too weak to provide frames at the frame rate of the display device because the display may be running at a high frame rate and/or high resolution that is beyond the processing strength of the GPU.

Importantly, embodiments of the invention include a frame lock signal, e.g. sent by a screen refresh controller, that may instruct the GPU to generate frames in synchronization with the display. Accordingly, among other things, tearing artifacts may be avoided and/or the GPU may be able to rest for certain periods or render frames at a slower rate, thereby consuming power. Further, embodiments of the invention include a framelock signal that may instruct the GPU to generate only a subsection or partial update region of a frame such that an updated frame may be provided at a frame rate faster than the regular maximum frame generation rate of the GPU, thereby approaching or reaching the display frame rate.

Various embodiments of the present invention may include a graphics processor operable to generate video frames, wherein the graphics processor is operable to begin generating a partial update region of a video frame upon receiving a framelock signal. Further, a screen refresh controller may be communicatively coupled with the graphics processor, wherein the screen refresh controller is operable to receive partial update regions of video frames from the graphics processor and send framelock signals to the graphics processor. Additionally, a display device may be communicatively coupled with the screen refresh controller, wherein the display device is operable to receive and display video frames from the screen refresh controller.

In some embodiments of the invention, a first frame may be displayed on a display device during a first frame cycle of the display device. Further, a first framelock signal may be sent to a graphics processor at the beginning of a second frame cycle of the display device, wherein the first framelock signal causes the graphics processor to generate a partial update region of the first frame to form a second frame. Additionally, the second frame may be sent to the display device for display.

Various embodiments of the invention may include a processing unit, a graphics processing system coupled to the processor and comprising a graphics processor, wherein the graphics processor is operable to generate video frames and begin generating a partial update region of a video frame upon receiving a framelock signal, and memory coupled to the graphics processing system. Further, a screen refresh controller may be communicatively coupled with the graphics processor, wherein the screen refresh controller is operable to receive partial update regions of video frames from the graphics processor and send framelock signals to the graphics processor. Additionally, a display device may be communicatively coupled with the screen refresh controller, wherein the display device is operable to receive and display video frames from the screen refresh controller.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 is a block diagram of an example of a computer system capable of implementing embodiments according to the present invention.

FIG. 2 is a block diagram view of an exemplary framelocking system, according to an embodiment of the present invention.

FIG. 3 is a timing diagram of exemplary communication signals between and/or processing of various components, according to an embodiment of the present invention.

FIG. 4A is a timing diagram of exemplary communication signals between and/or processing of various components, according to an embodiment of the present invention.

FIG. 4B is a timing diagram of exemplary communication signals between and/or processing of various components, according to an embodiment of the present invention.

FIG. 5 is a depiction of a video frame with tearing.

FIG. 6 is a depiction of a video frame without tearing, according to an embodiment of the present invention.

FIG. 7 is a depiction of a video frame partial update region, according to an embodiment of the present invention.

FIG. 8 is a timing diagram of exemplary communication signals between and/or processing of various components, according to an embodiment of the present invention.

FIG. 9 depicts a flowchart 900 of an exemplary process of performing a partial update, according to an embodiment of the present invention.

FIG. 10 depicts a flowchart 1000 of an exemplary process of using a framelock signal, according to an embodiment of the present invention.

FIG. 11 depicts a flowchart 1100 of an exemplary process of using a framelock signal, according to an embodiment of the present invention.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

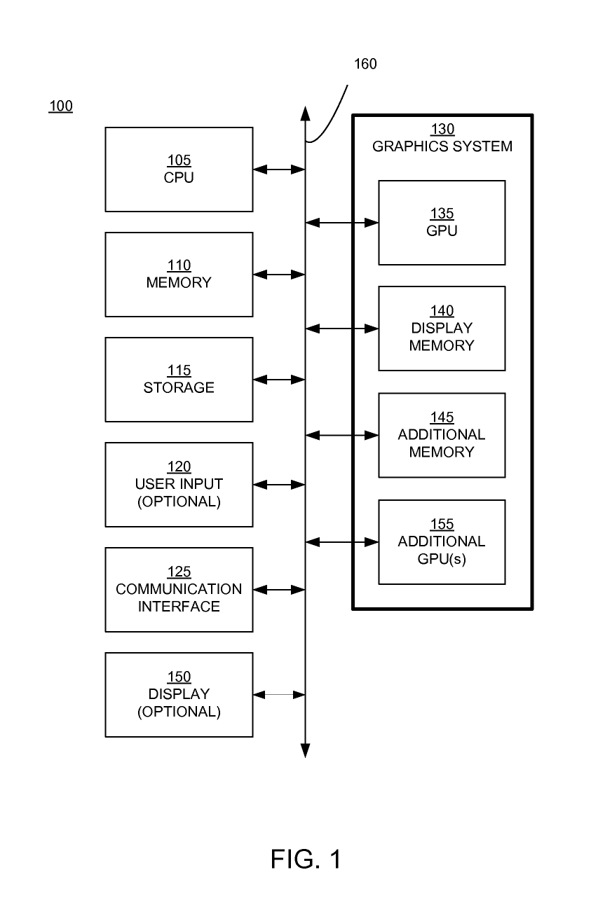

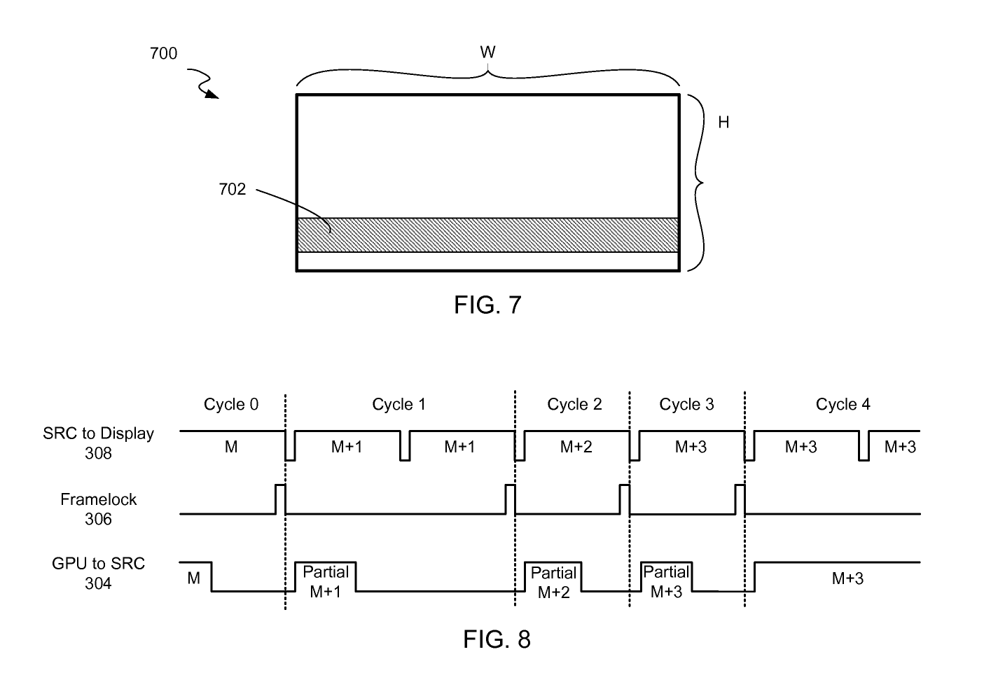

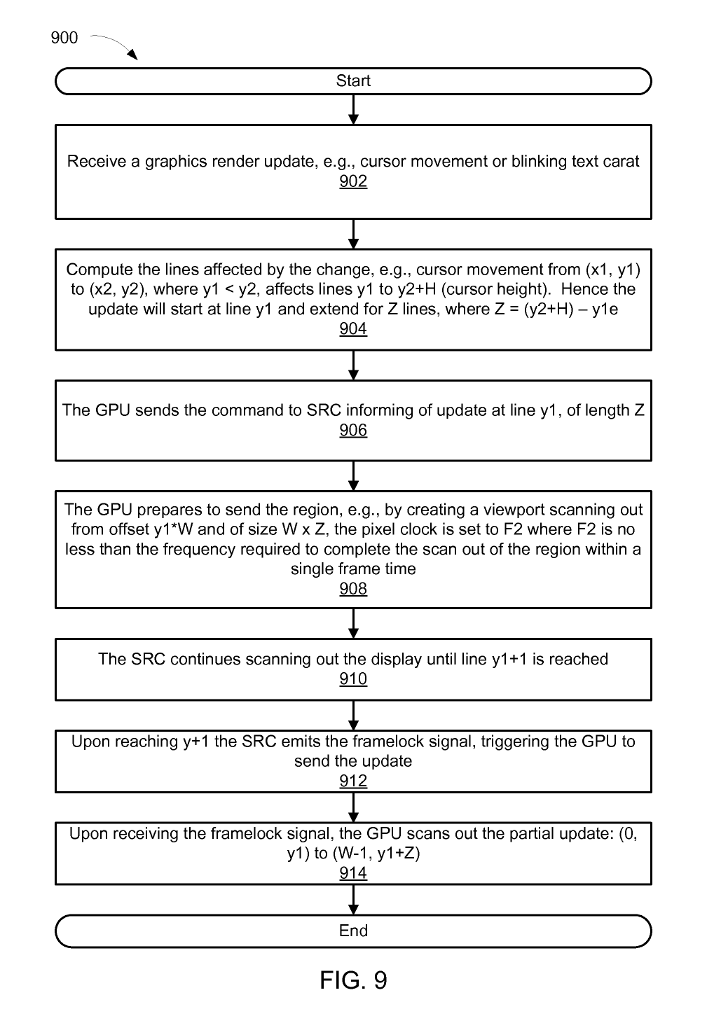

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “generating,” “sending,” “decoding,” “encoding,” “accessing,” “streaming,” “determining,” “identifying,” “caching,” “reading,” “writing,” or the like, refer to actions and processes (e.g., flowcharts 1000 or 1100 of FIG. 10 or 11, respectively) of a computer system or similar electronic computing device or processor (e.g., system 160 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 is a block diagram of an example of a computer system 100 capable of implementing embodiments according to the present invention. In the example of FIG. 1, the computer system 100 includes a central processing unit (CPU) 105 for running software applications and optionally an operating system. Memory 110 stores applications and data for use by the CPU 105. Storage 115 provides non-volatile storage for applications and data and may include fixed disk drives, removable disk drives, flash memory devices, and CD-ROM, DVD-ROM or other optical storage devices. The optional user input 120 includes devices that communicate user inputs from one or more users to the computer system 100 and may include keyboards, mice, joysticks, touch screens, and/or microphones.

The communication or network interface 125 allows the computer system 100 to communicate with other computer systems via an electronic communications network, including wired and/or wireless communication and including the Internet. The optional display device 150 may be any device capable of displaying visual information in response to a signal from the computer system 100. The components of the computer system 100, including the CPU 105, memory 110, data storage 115, user input devices 120, communication interface 125, and the display device 150, may be coupled via one or more data buses 160.

In the embodiment of FIG. 1, a graphics system 130 may be coupled with the data bus 160 and the components of the computer system 100. The graphics system 130 may include a physical graphics processing unit (GPU) 135 and graphics memory. The GPU 135 generates pixel data for output images from rendering commands. The physical GPU 135 can be configured as multiple virtual GPUs that may be used in parallel (concurrently) by a number of applications executing in parallel.

Graphics memory may include a display memory 140 (e.g., a frame buffer) used for storing pixel data for each pixel of an output image. In another embodiment, the display memory 140 and/or additional memory 145 may be part of the memory 110 and may be shared with the CPU 105. Alternatively, the display memory 140 and/or additional memory 145 can be one or more separate memories provided for the exclusive use of the graphics system 130.

In another embodiment, graphics processing system 130 includes one or more additional physical GPUs 155, similar to the GPU 135. Each additional GPU 155 may be adapted to operate in parallel with the GPU 135. Each additional GPU 155 generates pixel data for output images from rendering commands. Each additional physical GPU 155 can be configured as multiple virtual GPUs that may be used in parallel (concurrently) by a number of applications executing in parallel. Each additional GPU 155 can operate in conjunction with the GPU 135 to simultaneously generate pixel data for different portions of an output image, or to simultaneously generate pixel data for different output images. Further, each GPU 155 may be coupled with one another and/or the GPU 135 through a data bus (not shown) within the graphics system 130.

Each additional GPU 155 can be located on the same circuit board as the GPU 135, sharing a connection with the GPU 135 to the data bus 160, or each additional GPU 155 can be located on another circuit board separately coupled with the data bus 160. Each additional GPU 155 can also be integrated into the same module or chip package as the GPU 135. Each additional GPU 155 can have additional memory, similar to the display memory 140 and additional memory 145, or can share the memories 140 and 145 with the GPU 135.

For example, a computer program for determining a framelock signal frequency may be stored on the computer-readable medium and then stored in system memory 110 and/or various portions of storage devices 115. When executed by the CPU 105, the computer program may cause the CPU 105 to perform and/or be a means for performing the functions required for carrying out the framelock signal frequency determination processes discussed.

Method and Apparatus for Sending Partial Frame Updates Rendered in a Graphics Processor to a Display Using Framelock Signals

A GPU may not be capable of providing, or it may not be preferable to provide, display frames at the frame rate of the display device. For example, the GPU may be too weak to provide frames at a rate faster than 30 Hz, while the display device may be capable of display frames at a rate of 120 or 240 Hz. Alternatively, for example, the GPU may be capable of providing frames at a higher frame rate, but not at certain high resolutions. Or, for example, the GPU may be capable of providing frames at a higher frame rate and resolution, but may be in a power saving mode. Alternatively, for example, the GPU may be part of a hybrid system including a weak and a strong GPU, where the weak GPU is unable to drive a high-resolution and/or high frame rate display. Ultimately, the display device may be running at a frame rate higher than the frame rate of the GPU.

A certain pixel clock speed may be required to drive a display at certain refresh rate and resolution. The pixel clock speed may have a relationship to power and performance, and some chips may not have enough power to support certain resolutions, e.g., chips in a handheld phone. Further, in some situations it may be preferable to run video at a slower frame rate (e.g., 24 fps films) on a display capable of displaying faster frame rates, which may conventionally introduce artifacts because the frame rates are not evenly matched.

In embodiments of the present invention, a display panel may include a local separate frame buffer, for example, to support low bandwidth GPUs and/or self-refresh capabilities. The local frame buffer may be used to store frames until they are ready to be scanned out to a display. Further, it is appreciated that the frame buffer may also be used advantageously in accordance with embodiments of the present invention as a rate conversion buffer, allowing pixels on a slower speed front-end to be buffered at a rate slower than that by which pixels are scanned onto a display panel at a back-end.

The scan out of the frames from the frame buffer may be synchronized with the frame rate of the display, as discussed below. Between consecutive frames, some frames may be similar to a previous frame. A GPU may only process the areas of the frame that are different from the previous frame, or an updated region. The updated region may be gradually rendered and sent to the frame buffer and/or the display. In accordance with embodiments of the present invention, a framelock signal may trigger the scan-out of a region at the right time for a slower update of that region to complete in a refresh.

In various embodiments, self-refreshing capabilities may be used and/or an intermediate buffer may be used that may accept pixels at one rate but display them at a different rate. In some embodiments, two memory buffers may be used, where a first buffer receives a frame while a second buffer is scanned out. Once the processes for each buffer completes, the process for each buffer may be switched, e.g. the first buffer may scan out while the second buffer receives the next frame. However, such a solution may require more memory since two buffers are used.

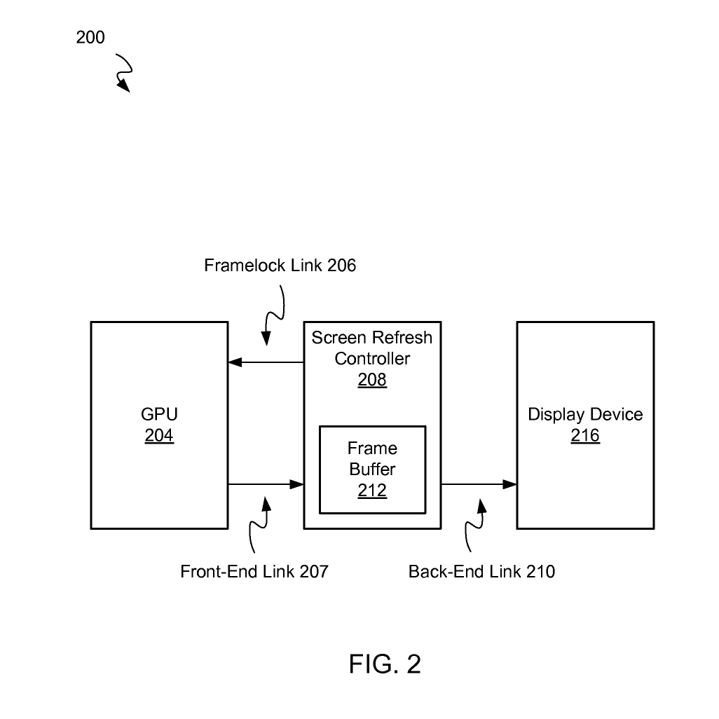

FIG. 2 is a block diagram view of an exemplary framelocking system 200, according to an embodiment of the present invention. FIG. 2 includes a graphics processing unit (GPU) 204, a screen refresh controller (SRC) 208, and a display device 216. The SRC 208 includes a frame buffer 212.

The GPU 204 may be communicatively coupled with the SRC 208, and the SRC 208 may be communicatively coupled with the display device 216. The GPU 204, SRC 208, and display device 216 may all be within a single device, for example, a mobile phone or a desktop computer. However, the GPU 204, SRC 208, and display device 216 may be in separate devices. For example, the GPU 204 may be in a computer system, the display device 216 may be in a display panel, and the SRC 208 may be in either the computer system or the display panel.

The GPU 204 may be operable to communicate with the SRC 208 through a front-end link 207. For example, the GPU 204 may provide video frames or other data to the SRC 208 through the front-end link 207. The video frames may be stored by the frame buffer 212. The SRC 208 may be operable to communicate with the display device 216 through a back-end link 210. The frame buffer 212 may eventually provide the stored video frames to the display 216 for displaying.

The SRC 208 may be operable to provide a framelock signal through a framelock link 206 to the GPU 204. The framelock signal may be operable to provide instructions to the GPU 204. For example, the framelock signal may, but is not limited to, instruct the GPU 204 to begin, stop, or delay processing frames.

It should be appreciated that the framelock link 206 and the front-end link 207 may be two separate links or the same link. In the latter case, a single link may be operable to provide bi-directional communication, thereby allowing the communication of video frames in one direction and framelock signals in the other direction. In the example of FIG. 2, the GPU 204 may render frames at a rate slower than the display device 216 is able to display them, and/or the GPU 204 may write frame data into the frame buffer 212 at a rate that is slower than the screen refresh controller 208 can read or send out the frames from the frame buffer 212.

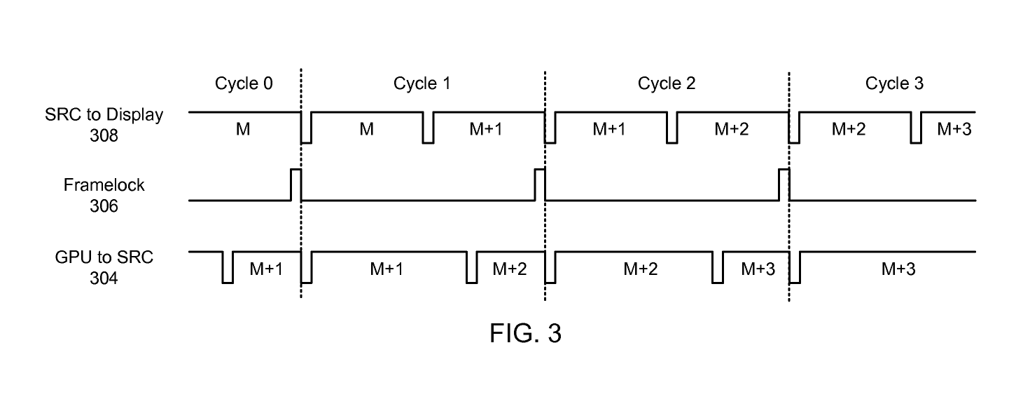

FIG. 3 is a timing diagram of communication signals between and/or processing of various components, according to an embodiment of the present invention. A GPU to SRC signal 304, a framelock signal 306, and an SRC to Display signal 308 may correspond to signals of the GPU 204, framelock link 206, and SRC 208 and/or display device 216, respectively.

As discussed above, the GPU 204 may not be capable of providing, or it may not be preferable to provide, frames at the frame rate of the display device 216. For example, the GPU 204 may be too weak to provide frames at a rate faster than 30 Hz, while the display device 216 may be capable of display frames at a rate of 120 or 240 Hz. Alternatively, for example, the GPU 204 may be capable of providing frames at a higher frame rate, but not at certain high resolutions. Or, for example, the GPU 204 may be capable of providing frames at a higher frame rate and resolution, but may be in a power saving mode. Ultimately, the display device 216 may be running at a frame rate higher than the frame rate of the GPU 204.

The framelock signal 306 may define the end of a cycle 0 and the beginning of a cycle 1. While the figures demonstrate signal transitions with the falling or rising edge of signals, it should be appreciated that the specific edge transitions shown may not be necessary. For example, the rising edge of the framelock signal 306 may indicate the beginning of a new signal instead of the falling edge of the framelock signal 306.

At the beginning of cycle 1, the SRC to Display signal 308 may be providing or scanning out a frame M to the display device 216. Alternatively, the frame M may have already been fully scanned out to the display device 216 in the previous cycle 0, and the display device 216 continues to display the frame. Or, the SRC 208 may instruct the display device 216 to continue displaying the frame M, or the SRC 208 may resend the frame M to the display device 216, and as a result, the display device 216 may continue displaying the frame M.

Meanwhile, during the beginning of cycle 1, the GPU 204 begins to provide a next frame M+1 through the GPU to SRC signal 304. The length of the M+1 region for the GPU to SRC signal 304 in cycle 1 may correspond to the processing and creation of the frame M+1. More specifically, at the beginning of the M+1 region, the GPU 204 begins to generate the frame M+1, and at the end of the M+1 region, the GPU 204 completes the generation of the frame M+1.

Because the frame rate of the display device 216 may be higher than the frame rate of the GPU 204, the SRC to Display signal 308 may complete frame periods faster than the GPU to SRC signal 304. Accordingly, in cycle 1 the SRC to Display signal 308 may finish the M frame period before the GPU to SRC signal 304 finishes the M+1 processing and/or communication signal. However, because the GPU to SRC signal 304 may finish the M+1 signal before the end of the cycle 1, the SRC 208 may begin scanning out the M+1 frame to the display device 216 concurrently with the processing and/or communication of the M+1 frame by the GPU 204. Accordingly, the SRC to Display signal 308 may first display the M frame followed by the M+1.

Once the GPU 204 completes the generation of the M+1 frame, it may move on to generating and/or communicating a next frame M+2, as shown by the GPU to SRC signal 304. However, another framelock signal transition from the SRC 208 to the GPU 204 may halt the generating and/or communicating of the M+2 frame. This framelock signal transition may end cycle 1 and begin a cycle 2. Because the M+2 frame is not ready for display, or even ready for scan out while the rest of the M+2 frame is provided, the display 216 may continue to display the M+1 frame.

The timing diagram of cycle 2 may be similar to that of cycle 1. For example, the display device 216 continues to show the previously provided M+1 frame because a new frame M+2 is not ready for display. While the GPU 204 is generating the new frame M+2, the display device 216 finishes a frame period and begins to read or display the new frame M+2, even though it is not done being generated. The generation of the new frame M+2 completes before the display starts a new cycle, and so the GPU 204 begins generating the next new frame M+3. Again, a framelock signal transition causes the GPU 204 to halt or pause the generation of the M+3 frame, and so on.

In this way, by using the framelock signal 306, smooth transitions between frames are provided on the display device 216. For example, the frames of the GPU 204 that were not generated and/or provided in sync or at the same frame rate of the display device 216 may be aligned with the frame rate cycles of the display device 216. Accordingly, artifacts like tearing may be avoided.

In one embodiment, the results of the partial frame generation that is interrupted by the framelock signal transition may be used in the next cycle. For example, the generation or communication of the M+2 frame in cycle 1 may be stopped by the framelock signal transition. However, in cycle 2 the GPU 204 may resume generating or communication the frame M+2 from where it left off, thereby more quickly completing the generation of frame M+2. The GPU 204 may then rest or go to a standby mode until the next framelock signal transition. As discussed above, this may require an intermediate buffer in the SRC 208 to prevent the M+2 pixels from the GPU 204 from overwriting the previously stored M+1 frame pixels.

As can be appreciated, the framelock signal transitions may be in sync with the frame rate of the display device 216 or SRC to Display signal 308. However, it should be appreciated that the framelock signal transitions may not occur at the same rate as the frame rate of the display device 216. In other words, the framelock signal may transition at half the rate, quarter the rate, eighth the rate, and so on, of the display device 216 frame rate. The framelock may occur at the beginning or end of cycles of the display device 216 frames.

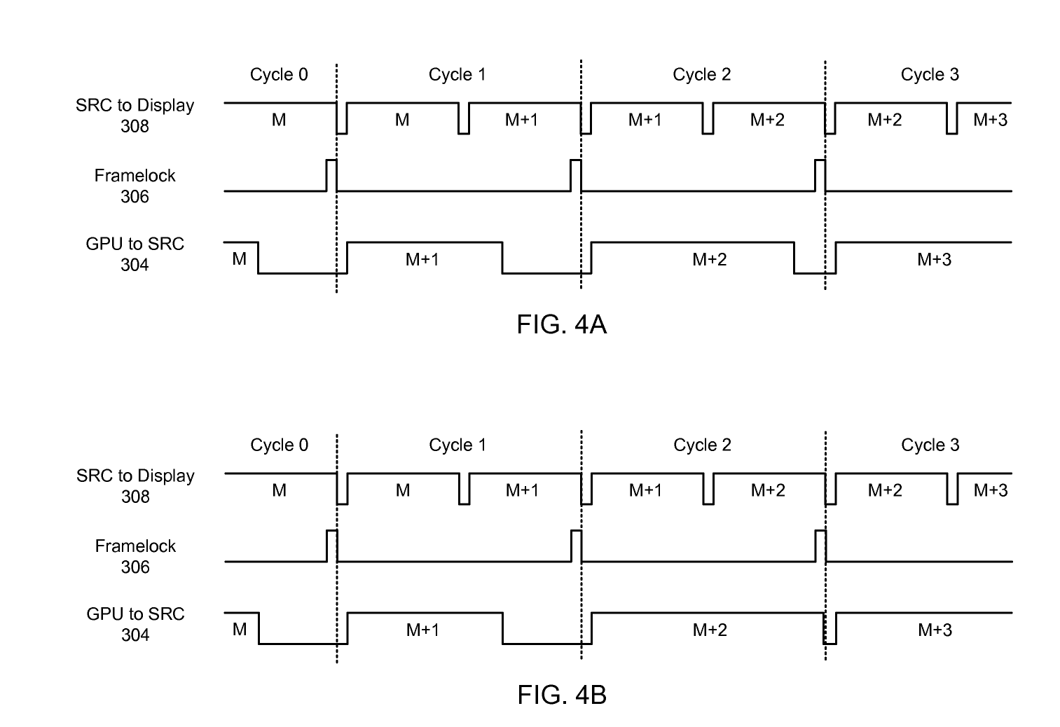

FIG. 4A is a timing diagram of communication signals between and/or processing of various components, according to an embodiment of the present invention. FIG. 4A is similar to FIG. 3 in that it includes the GPU to SRC signal 304, framelock signal 306, and SRC to Display signal 308, where the framelock signal 306 and SRC to Display signal 308 may be the same as those in FIG. 3.

The GPU to SRC signal 304 of FIG. 4A may be similar to the GPU signal of FIG. 3 in that it begins generating and/or communicating a frame at the beginning of a framelock signal transition. For example, the GPU to SRC signal 304 begins frame M+1 at the beginning of cycle 1, frame M+2 at the beginning of cycle 2, and so on.

Importantly, the GPU to SRC signal 304 of FIG. 4A may be different from the GPU signal of FIG. 3 in that it may rest or go to a standby mode after completing the generation of a frame. For example, in cycle 1 after the generation of M+1 is complete, the GPU 204 may wait until the next framelock signal transition before continuing work.

In addition, the GPU to SRC signal 304 of FIG. 4A may be different from the GPU signal of FIG. 3 in that it may more slowly generate a frame and/or slowly send out the generated frame. For example, in cycle 2, the GPU 204 may slowly generate the M+2 frame compared to the fastest rate the GPU 204 may generate the frame, e.g., the rate at which M+1 was generated (assuming that the M+1 frame represents the fastest rate the GPU 204 may generate frames).

FIG. 4B is a timing diagram of communication signals between and/or processing of various components, according to an embodiment of the present invention. FIG. 4B is similar to FIG. 4A, however, FIG. 4B demonstrates that the GPU 204 may use the entire time available before the next framelock signal to slowly generate or render a frame. For example, in cycle 2, the GPU 204 may continue to generate the M+2 frame through cycle 2 and complete the generation up until the subsequent framelock signal that begins cycle 3.

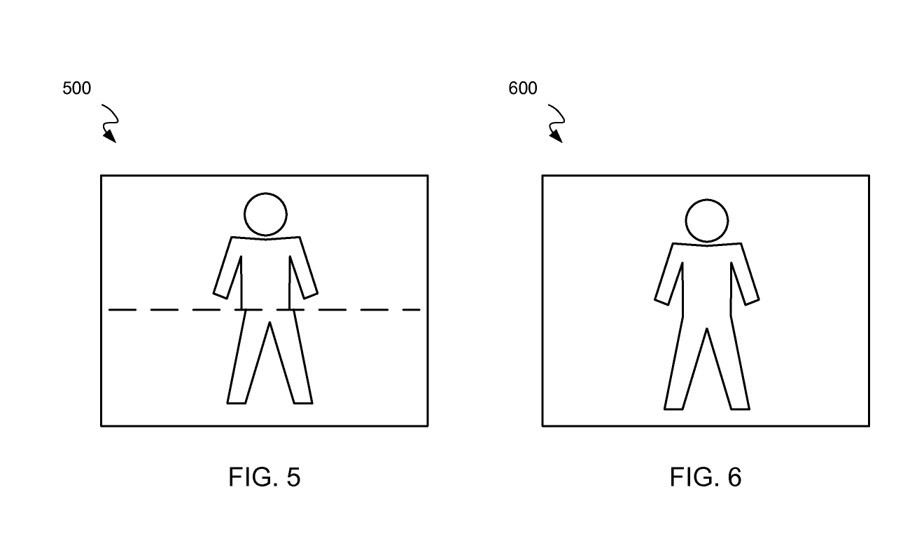

FIG. 5 is a depiction of a video frame 500 with tearing. When the front-end link 207 scan-out overlaps with the back-end link 210 scan-out, tearing may occur. Tearing may occur when a first portion of a video frame includes a first frame and a second portion of the video frame includes a second frame that was likely meant to entirely precede or follow the first frame. When the first and second frames are different but portions of each are shown in the same frame, a tearing artifact may appear. For example, if the frames depict the movement of a person, part of the person's body may appear ahead or behind another part of the body, as delineated by the dotted line in FIG. 5.

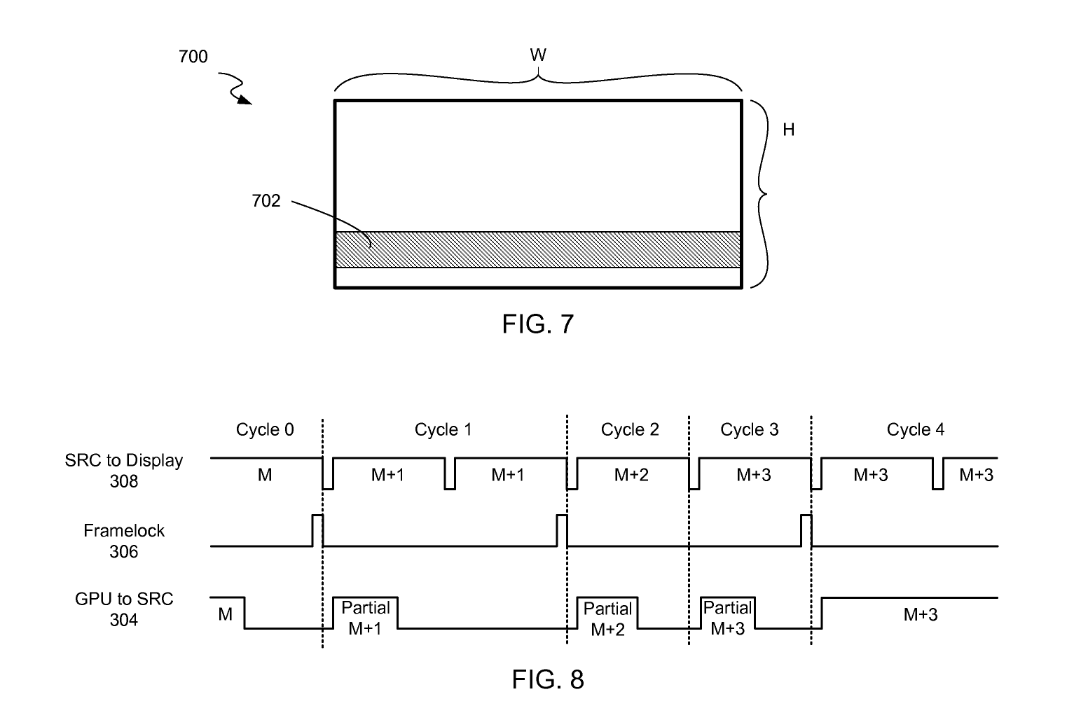

FIG. 6 is a depiction of a video frame 600 without tearing, according to an embodiment of the present invention. When a framelock signal is used to bring the GPU 204 in sync with the display device 216, a first frame may be prevented from overlapping a second frame. Accordingly, the display device 216 may be prevented from displaying tearing artifacts. For example, for the same frames depicting the movement of a person in FIG. 5, the person's body may be shown without any tearing, as shown in FIG. 6.

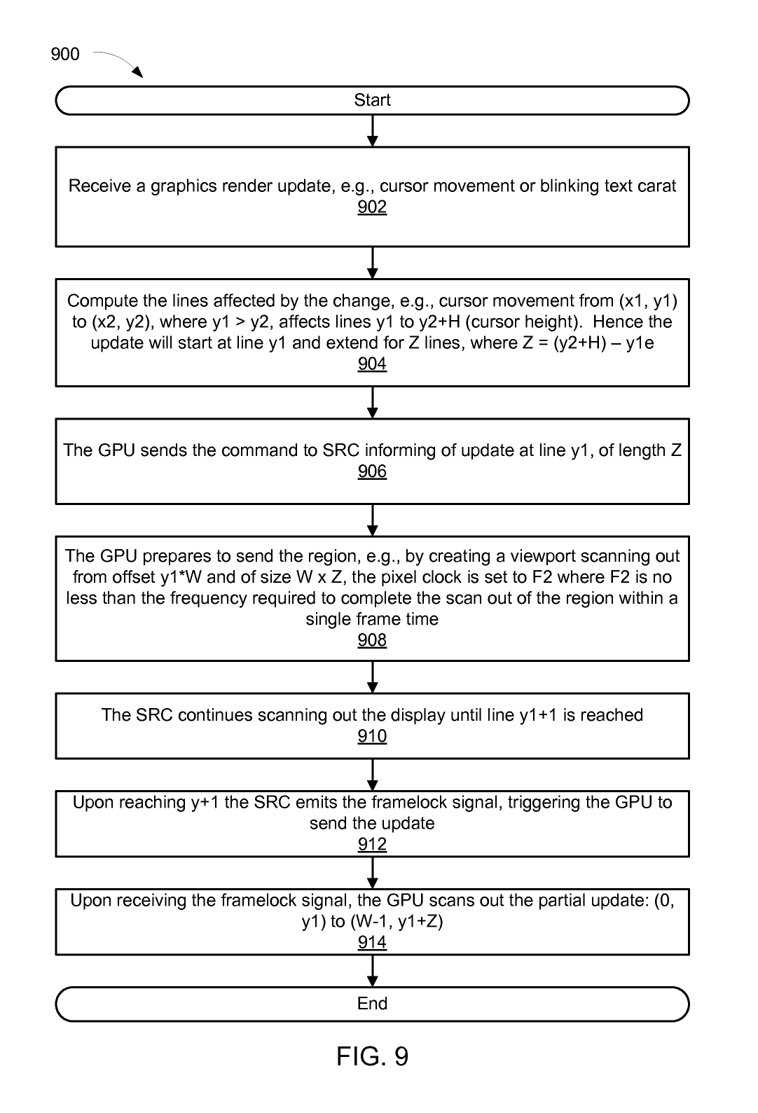

FIG. 7 is a depiction of a video frame 700 partial update region 702, according to an embodiment of the present invention. FIG. 7 includes a video frame 700, which in turn includes a partial update region 702. The partial update region 702 may be a region of the frame 700 that is different from a same region of an immediately preceding frame. The rest of the frame 700 may be the same or substantially similar to the immediately preceding frame.

For example, in some cases, consecutive frames may be similar to one another, except for changes in some regions of the frames. The changes may be minor or major. In such cases, the GPU 204 may only need to generate pixels for the regions that have changed and simply use the pixels that have been previously generated for the regions that have not changed.

For example, in a video game, only a portion of the screen may change, whereas the rest of the screen need not be updated. Or, while working with a word processing application, only a portion of the screen, e.g., where the editing of the text is occurring, needs to be updated. As a result, the GPU 204 may do less work than is required to generate an entire frame. Accordingly, the GPU 204 may have more time to rest, or may have more time to generate additional frames when it would otherwise have not.

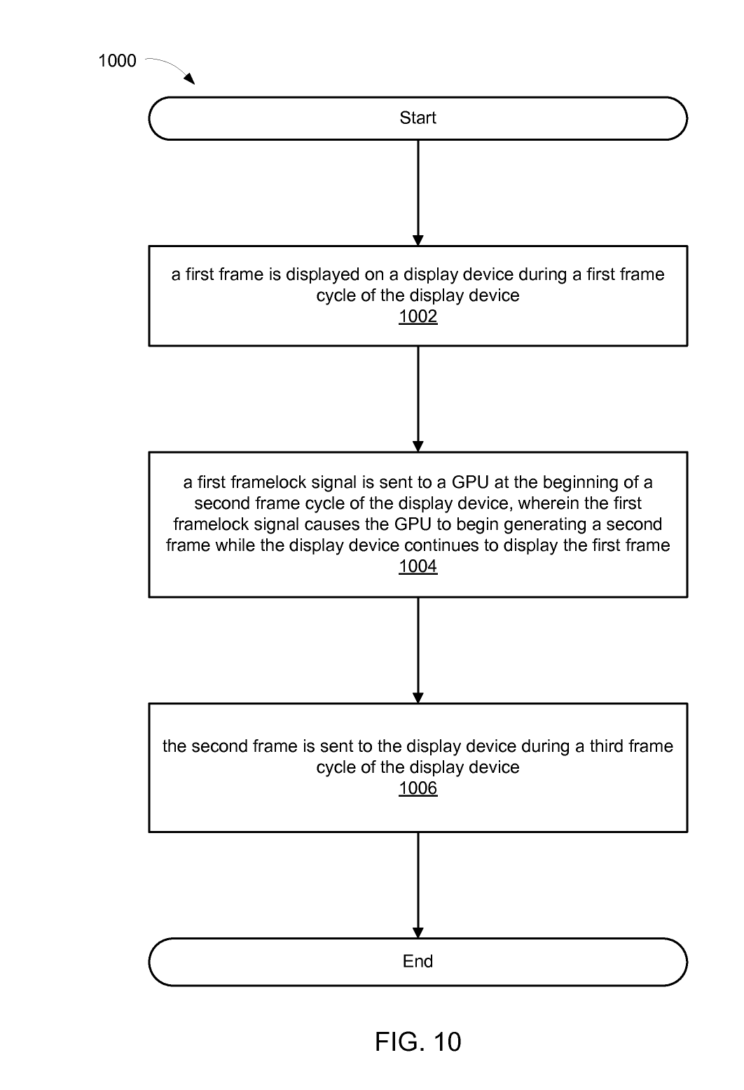

FIG. 8 is a timing diagram of communication signals between and/or processing of various components, according to an embodiment of the present invention. The frame M+1 of FIG. 8 may require only a partial update from frame M. In a cycle 1 of the timing diagram, the GPU 204 may finish generating the partial update region corresponding to the M+1 frame much more quickly than the time it would take to generate a full frame. As a result, the GPU 204 may rest and save power for the remainder of cycle 1.

Alternatively, the frame M+2 may require only a partial update from frame M+1. If the GPU 204 can finish generating the partial update of frame M+2 quickly enough, in cycle 2 the display device 216 may begin scanning out the frame M+2 because the GPU 204 may finish generating the frame M+2 before the end of the display device's 216 frame period.

Further, assuming that frame M+3 only requires a partial update from frame M+2, instead of resting for the remainder of a cycle that may be as long as cycle 1, another framelock signal from the SRC 208 may instruct the GPU 204 to begin generating the partial update earlier for frame M+3. Accordingly, the display device 216 may begin scanning out the frame M+3 earlier at the beginning of a cycle 3 instead of allowing a longer version of cycle 2. As a result, even though the GPU 204 may be otherwise too weak to keep up with the frame rate of the display device 216, the GPU 204 may still provide frames at the frame rate of the display device 216 because it may only generate the partial update region.

The SRC 208 may drive the framelock signal at exactly the right interval to allow the slower or partial update region to be sent and integrated into the frame without tearing. In one embodiment, the GPU 204 may wait for the framelock signal before sending out the partial update region. In another embodiment the GPU 204 may continually scan-out the partial update region and use the framelock signal as a reset signal which crash-locks the scan-out back to line 0 pixel 0 at exactly the right time to begin scan-out of the region when the SRC 208 has demanded it.

Partial frame updates allow the GPU 204 to specify the sub-portion of the screen that will be transferred. In one embodiment this can be specified as a region, e.g., as a vertical line offset and a number of lines (where each line is the full-screen width). The region that will be transferred can be specified by vertical offset and number of lines. The use of a region-based update, rather than based on rectangular area, reduces the overhead for transferring an update and simplifies the design considerably, enabling application on, for example, existing eDP interfaces.

It should be noted that in some cases, the SRC 208 may send or emit the framelock signal at the beginning of a frame scan out operation. In other cases, the SRC 208 may send or emit the framelock signal at other points of time.

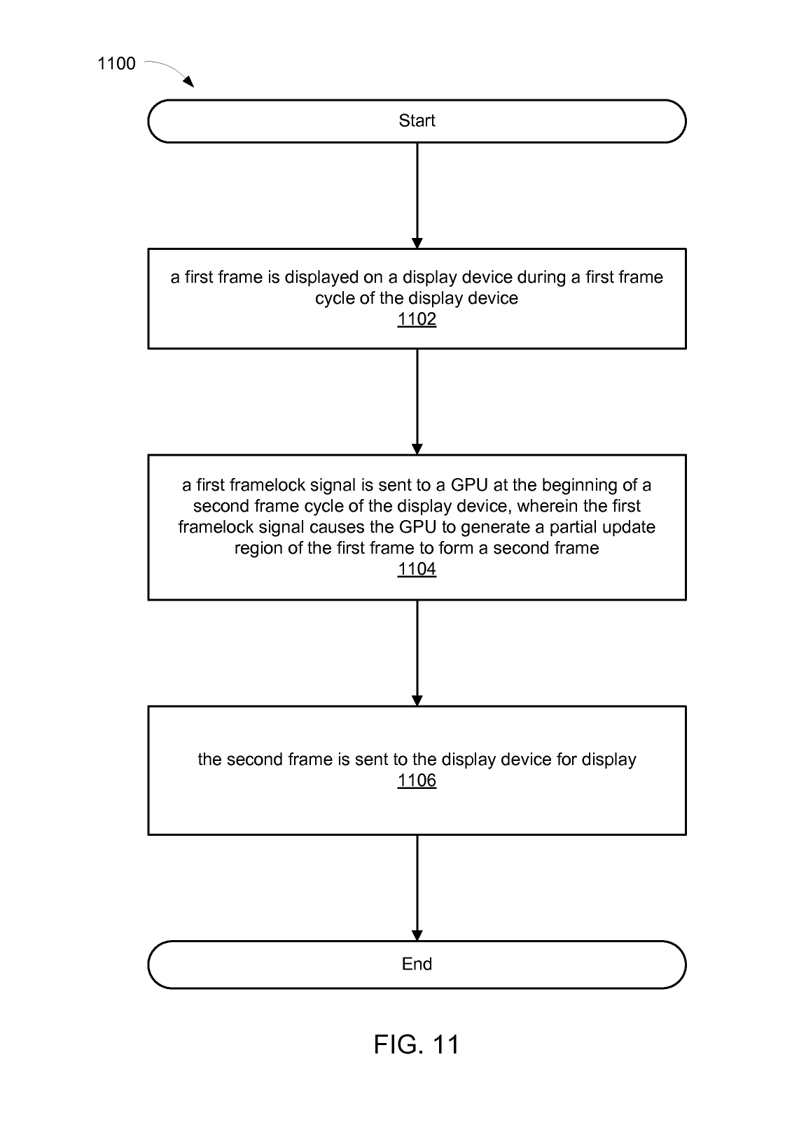

FIG. 9 depicts a flowchart 900 of an exemplary process of performing a partial update, according to an embodiment of the present invention. For example, a partial update may be performed for a screen of size W by H, requiring a pixel clock of F1.

In a block 902, a graphics render update is received, e.g., cursor movement or blinking text carat. In a block 904, the lines affected by the change are computed, e.g., cursor movement from (x1, y1) to (x2, y2) where y1>y2 affects lines y1 to y2+H (cursor height). Hence the update will start at line y1 and extend for Z lines, where Z=(y2+H)−y1.

In a block 906, the GPU sends the command to SRC informing of update at line y1, of length Z. In a block 908, the GPU prepares to send the region, e.g., by creating a viewport scanning out from offset y1*W and of size W×Z, the pixel clock is set to F2 where F2 is no less than the frequency required to complete the scan out of the region within a single frame time.

In a block 910, the SRC continues scanning out the display until line y1+1 is reached. In a block 912, upon reaching y1+1, the SRC emits the framelock signal, triggering the GPU to send the update. In a block 914, upon receiving the framelock signal, the GPU scans out the partial update: (0, y1) to (W−1, y1+Z). It should be noted that in some cases, the SRC may send or emit the framelock signal at the beginning of a frame scan out operation. In other cases, the SRC may send or emit the framelock signal at other points of time.

In order to ensure that the front-end link 207 scan-out does not overlap the back-end link 210, causing tearing, the framelock signal is used to synchronize the front-end link 207 scan-out so that it begins exactly after the first line in the region being updated is scanned out. Since the back-end link 210 timings may be faster than the front-end link 207 scan-out, the update may only update pixels that have already been scanned out. This is important to avoid tearing.

The slowest rate at which display regions can be transferred may be determined by the time taken for the given size of the region and the pixel clock used to transfer. For example: Tf (Front-End Scan Time)=(Region_Width*Region_Height)/(Front-End-Pixel-Clock-Frequency).

It is appreciated that, the time may not exceed the time for the backend frame to be displayed plus the time to display the updated region: Td (Display Time)=((Region_width*Region height)+(Total_Width*Total_Height))/Back-End-Pixel-Clock-Frequency.

Further, it is appreciated that assuming the transfer is delayed to start after the first line which is to be updated, then the time taken must not be so long as to cause overlap with the same region on the next back-end refresh: The time is thus subtracting the time for one scanline, Tdl=Width/Back-End PixClk-Frequency, and Time=Td (Display Time)−Tdl.

In one embodiment, the update region could be the entire frame. In this case, Td would be two full frame periods. As long as the GPU could send data at half the rate of the SRC 208, it could send a full frame update every other frame with no tearing. This behavior may be similar to the behavior discussed with respect to FIGS. 3 and 4.

Thus, it is also possible to slowly render an entire frame by sending it region by region. To mitigate tearing artifacts, the SRC 208 may allocate double the frame buffer space and support the command to flip the display from front to back, when the back buffer is assembled. Thereafter, frame updates may be sent region by region. This may limit the maximum frame rate at which content can be displayed. However, if the pixel clock is halved, then the maximum region size is at least half the screen size, meaning half the rate (e.g. 60 Hz) to transmit a full frame, which may be sufficient for 30 fps (video) or 24 fps (film) content.

FIG. 10 depicts a flowchart 1000 of an exemplary process of using a framelock signal, according to an embodiment of the present invention. In a block 1002, a first frame is displayed on a display device during a first frame cycle of the display device. For example, in FIG. 3, a first frame M during the last frame cycle of Cycle 0.

In a block 1004, a first framelock signal is sent to a GPU at the beginning of a second frame cycle of the display device, wherein the first framelock signal causes the GPU to begin generating a second frame while the display device continues to display the first frame. For example, in FIG. 3, a framelock signal is sent in between Cycle 0 and Cycle 1, where the GPU begins to process the frame M+1 while the display continues to display the frame M. The SRC may instruct the display device to continue displaying the frame M, or the SRC may resend the frame M to the display device, and as a result, the display device may continue displaying the frame M.

In a block 1006, the second frame is sent to the display device during a third frame cycle of the display device. For example, in FIG. 3, the frame M+1 is sent to the display during the last frame cycle of Cycle 1.

FIG. 11 depicts a flowchart 1100 of an exemplary process of using a framelock signal, according to an embodiment of the present invention. In a block 1102, a first frame is displayed on a display device during a first frame cycle of the display device. For example, in FIG. 8, a first frame M is displayed during the last frame cycle of Cycle 0.

In a block 1104, a first framelock signal is sent to a GPU at the beginning of a second frame cycle of the display device, wherein the first framelock signal causes the GPU to generate a partial update region of the first frame to form a second frame. For example, in FIG. 8, a framelock signal is sent in between Cycle 0 and Cycle 1, where the GPU generates a partial update region of frame M to form frame M+1.

In a block 1106, the second frame is sent to the display device for display. For example, in FIG. 8, frame M+1 is sent to the display in the first and/or second frame cycle of Cycle 1. The second frame may be sent to the display device by a screen refresh controller.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. An apparatus comprising:
a graphics processor operable to generate video frames, wherein said graphics processor is operable to begin generating a partial update region of a video frame upon receiving a framelock signal;
a screen refresh controller communicatively coupled with said graphics processor, wherein said screen refresh controller is operable to receive partial update regions of video frames from said graphics processor and send framelock signals to said graphics processor; and
a display device communicatively coupled with said screen refresh controller, wherein said display device is operable to receive and display video frames from said screen refresh controller.

2. The apparatus of claim 1, wherein when said graphics processor begins generating a first partial update region of a first video frame upon receiving a framelock signal, said screen refresh controller is operable to scan out to said display device at least a portion of said first video frame while said graphics processor generates said first partial update region.

3. The apparatus of claim 2, wherein after a completion of generating said first partial update region and before receiving another framelock signal, said graphics processor is operable to begin generating a second partial update region of a second video frame.

4. The apparatus of claim 1, wherein said partial update region of said video frame comprises a subsection of a previous video frame.

5. The apparatus of claim 1, wherein said graphics processor is operable to rest after completing generating said video frame until receiving another framelock signal from said screen refresh controller.

6. The apparatus of claim 1, wherein said graphics processor generates said video frame at a generation rate slower than a maximum generation rate of said graphics processor but sufficiently fast to complete said generation before receiving a subsequent framelock signal from said screen refresh controller.

7. The apparatus of claim 1, wherein said graphics processor is operable to generate video frames at a generation rate slower than a frame rate at which said display device is operable to display video frames.

8. The apparatus of claim 1, wherein said screen refresh controller is operable to send a framelock signal in synchronization with a beginning of a frame scan out operation of said display device.

9. A method comprising:
displaying a first frame on a display device during a first frame cycle of said display device;
sending a first framelock signal to a graphics processor at the beginning of a second frame cycle of said display device, wherein said first framelock signal causes said graphics processor to generate a partial update region of said first frame to form a second frame; and
sending said second frame to said display device for display.

10. The method of claim 9, wherein said sending said second frame occurs during said second frame cycle of said display device.

11. The method of claim 9, further comprising sending at least a portion of said second frame while said graphics processor generates said first partial update region of said first frame.

12. The method of claim 9, wherein said sending said second frame to said display device begins before a completion of said generating said second frame.

13. The method of claim 9, further comprising resting said graphics processor after said graphics processor completes generating said second frame until receiving a second framelock signal

14. The method of claim 9, wherein said generating said second frame occurs at a generation rate slower than a maximum generation rate of said graphics processor but sufficiently fast to complete said generating before receiving a second framelock signal.

15. A computer system comprising:
a processing unit;
a graphics processing system coupled to said processor and comprising a graphics processor, wherein said graphics processor is operable to generate video frames and begin generating a partial update region of a video frame upon receiving a framelock signal;
memory coupled to said graphics processing system;
a screen refresh controller communicatively coupled with said graphics processor, wherein said screen refresh controller is operable to receive partial update regions of video frames from said graphics processor and send framelock signals to said graphics processor; and
a display device communicatively coupled with said screen refresh controller, wherein said display device is operable to receive and display video frames from said screen refresh controller.

16. The computer system of claim 15, wherein when said graphics processor begins generating a first partial update region of a first video frame upon receiving a framelock signal, said screen refresh controller is operable to scan out to said display device at least a portion of said first video frame while said graphics processor generates said first partial update region.

17. The computer system of claim 16, wherein after a completion of generating said first partial update region and before receiving a second framelock signal, said graphics processor is operable to begin generating a second partial update region of a second video frame.

18. The computer system of claim 15, wherein said partial update region of said video frame includes a subsection of a previous video frame.

19. The computer system of claim 15, wherein said graphics processor is operable to rest after completing generating said video frame until receiving a second framelock signal from said screen refresh controller.

20. The computer system of claim 15, wherein said graphics processor generates said video frame at a generation rate slower than a maximum generation rate of said graphics processor but sufficiently fast to complete said generation before receiving a second framelock signal from said screen refresh controller.
